(19) United States
(12) Patent Application Publication
(10) Pub. No.: US 2007/0115397 A1
(43) Pub. Date: May 24, 2007

(54) Projection display with internal calibration bezel for video

(75) Inventors: Mark T. Bolas, Mountain View, CA (US); Ian E. McDowall, Mountain View, CA (US)

Correspondence Address: Crockett & Crockett, Suite 400, 24012 Calle De La Plata, Laguna Hills, CA, 92653, US

(73) Assignee: Fakespace Labs, Inc.

(21) Appl. No.: 11/165,812

(22) Filed: Jun. 24, 2005

(51) Int. Cl. H04N 17/02; H04N 3/26

(52) U.S. Cl. 348/745; 348/189

(57) ABSTRACT

A projection display including a calibration bezel which forms a visual fiducial at the edge of a display screen. The calibration bezel may form a complete or partial border around the display screen and may be oriented at an angle to the display screen. Thus, a comparatively larger angle exists between light rays emanating from the bezel to the camera than in a conventional setup that has a surface planar with respect to the display screen. This makes it easier for electronics to locate the edge of the display in images captured by the camera, facilitating a more efficient camera setup process and an improved picture alignment process. The calibration bezel further allows electronics to quickly locate and see images at the perimeter that defines the edge of a large screen rear projection monitor screen.

### FIELD OF THE INVENTIONS

The inventions described below relate to the field of video projection and more specifically to automated calibration of video projection systems.

### BACKGROUND OF THE INVENTION

It is advantageous in large screen rear projection monitors to provide a camera that acts as a sensor in a feedback control loop. This camera can watch the images displayed by the image projection system in order to notice defects in the projected images. These defects may include but are not limited to distorted images, images that are not correctly centered (linearly or rotationally) on the display screen, chromatic aberrations, or the like.

Shipping and handling a large screen rear projection monitor may cause optical components such as projection lenses and fold mirrors to move out of alignment, resulting in the previously mentioned problems. Any of these problems is undesirable to the consumer watching the large screen rear projection monitor.

The angle of reflection of the projected image from the back of the projector screen does not provide the best surface for gauging the quality of the projected image. The shallowness of the light rays' angles leads to image related problems. The electronics that monitor the images taken by the feedback control camera have difficulty recognizing portions of pictures at the outside edge of the camera's field of view. This is due to the way the camera's lens collects light and projects it onto a camera sensor, such as a charge coupled device (CCD) or a complementary metal oxide semiconductor (CMOS). Light rays from features at the center of the display screen to the camera have very steep angles (with respect to the display screen), and the angle between light rays pointing from the boundaries of such features (for example, a one inch square) will be comparatively large. If, however, these same features are located at the very edge of the display screen, then the light rays from the features to the camera will be very shallow (again, with respect to the screen), and the angle between light rays emanating from the boundaries of a feature (for example, a one inch square) will be extremely small. The magnitude of the angle between the boundary light rays is proportional to the number of camera sensor pixels that the feature is projected onto. The more pixels devoted to a feature in an image, the easier it is for electronics or software to recognize that feature. Thus, due to the geometry of the camera/lens/display screen setup, features at the center of the screen take up comparatively more pixels versus features of the same linear size at the very edge of the screen. This makes it very difficult for electronics to see the edge of the screen and consequently images projected on the screen.

It is important during both an initial camera calibration stage and in subsequent use to locate the edge of the screen within the images taken by the feedback control camera.

What is needed is a technique for automatically detecting and correcting misalignments, aberrations or other imperfections in the projected image from a surface that provides better reflectivity.

### SUMMARY

A video projection monitoring and calibration technique discussed below includes a camera or other image sensor capable of watching images displayed on the internal side of the image screen of a rear projection video monitor. The image projection system can monitor how projected images look and can adjust the way the images are projected in order to correct detected problems.

For aesthetic and calibration related reasons the camera should be located within the large screen rear projection monitor, looking at the surface of the display screen where images are projected. This surface is opposite the surface that viewers watch. Unfortunately, locating the camera within the large screen rear projection monitor cabinet forces the camera to sit very close to the display screen, especially in the case of thin cabinet rear projection monitors. This means that the light rays reaching the camera from the furthest edges of the display screen are close to parallel to the screen. The camera therefore needs an extremely wide-angle lens, or a fish-eye lens, to see the entire area of the display screen. For example, suppose a feedback control camera is located six inches directly behind the center of a fifty inch (diagonal), 16:9 aspect ratio display screen. A light ray pointing from a corner of the screen to the camera will have a roughly 13.5 degree angle with respect to the screen.

During the initial camera calibration stage a mapping function is created that maps the location of pixels within the camera's images to the physical locations on the display screen. Finding the edge of the screen quickly reveals the geometry of the camera relative to the display screen. This mapping function is then stored in the electronics within the large screen rear projection monitor. When used, the electronics can use images collected by the feedback control camera and, combined with the mapping function, determine the location of a projected image on the display screen and thereby establish if it has shifted or warped out of position. Again, being able to quickly locate the edge of the display screen facilitates this diagnostic process.

A video projection system may include a transmissive display screen having a front side and a rear side, a projector having one or more optical elements forming an image path to the rear side of the display screen, a calibration bezel in the image path, means for collecting calibration data having a view of a portion of the display screen or a portion of the calibration bezel, or both, and an image processing means using collected calibration data to adjust image data for projection by the projector.

The calibration bezel forms a visual fiducial or reference at the edge of a display screen in a large screen rear projection monitor. The calibration bezel may include one or more elements to form a complete or partial border around the display screen and the bezel elements may be oriented at an angle relative to the display screen. Thus, a comparatively larger angle exists between light rays reflected from the bezel to the camera than in a conventional setup that has a surface planar with respect to the display screen. This makes it easier for electronics or software to locate the edge of the display in images captured by the camera, facilitating a more efficient camera setup process and an improved picture alignment process. The calibration bezel further allows electronics to quickly locate and see images at the perimeter that defines the edge of a large screen rear projection monitor screen.

### BRIEF DESCRIPTION OF THE DRAWINGS

FIG. 1 is a side view block diagram of a rear projection video display including a calibration system.

FIG. 2 is a cross section view of the calibration system of FIG. 1.

FIG. 3 is a front view of a video projection screen and bezels.

FIG. 4 is a cross section view of the calibration system of FIG. 1 illustrating the geometry of a calibration bezel.

FIG. 5 is a cross section view of the calibration system of FIG. 1 illustrating the geometry of relative to the display screen.

FIG. 6 is a rear view of a video projection screen and alternate configuration of a calibration bezel.

FIG. 7 illustrates a portion of an image captured by a camera in the back of a rear projection monitor.

FIG. 8 illustrates a portion of an image captured by a camera in the back of a rear projection monitor.

### DETAILED DESCRIPTION OF THE INVENTIONS

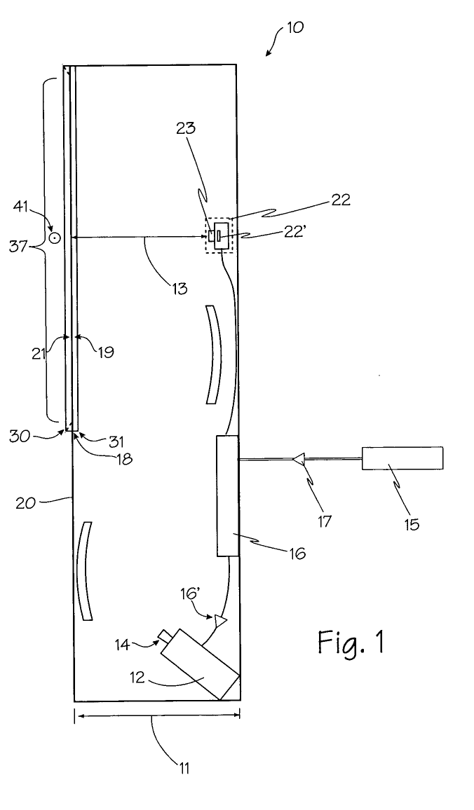

Referring now to FIG. 1, rear projection display device 10 includes projector 12, projection optics 14, control system 16, screen 18, cabinet 20, camera 22, and front bezel 30 and a calibration bezel 31. Rear projection display device 10 may be of a thin type, meaning that the depth of cabinet 20, represented by distance 11, may be less than fourteen inches. Rear projection display device 10 may be used, for example, as a television, a home cinema, or for any other suitable application. Projector 12 is mounted below horizontal centerline 41 of screen 18 and projects upwards, off-axis, into viewing area 37 of screen 18. It is set up to electronically receive signals 16′ from control system 16. Projector 12 may be a single microdisplay projector for use in a rear projection imaging system and thus may use a transmissive liquid crystal display (LCD) imager, a digital micromirror devices (DMD) imager, or a liquid crystal on silicon (LCOS) imager, or any other suitable technology.

The microdisplay imager in projector 12 may be an HD microdisplay, meaning that the display contains electronically controlled pixels arrayed in 1280 columns by 720 rows. The operation of an HD microdisplay projector is familiar to those of skill in the art. Projector 12 may be a multiple microdisplay projector with resolution greater or less than HD without departing from the spirit of the invention. Note that the distances and relative size of objects in FIG. 1-6 are not to scale.

A projected image radiates from projector 12 through projection optics 14. Although projection optics 14 are shown schematically in FIG. 1 as a single lens, projection optics 14 may include multiple lenses, mirrors, and other optical devices. Projection optics 14 projects an image from projector 12 on to rear surface 19 of screen 18. Screen 18 is transmissive so that the image projected on to surface 19 may be clearly be seen by viewers looking at front surface 21. Screen 18 may be, for example, a fresnel lens and diffuser or any other suitable diffusive screen material.

Control system 16 is responsible for receiving input video images 17 from any suitable video input device 15, re-sampling the images to convert them to a pixel based images, and turning the corresponding microdisplay pixels on and off in order to display the images. Control system 16 are also responsible for performing the picture alignment process aided by camera 22. Control system 16 may include non-volatile memory, a microprocessor, integrated circuits, and the like. Similarly, control system 16 may be implemented in hardware, software, firmware or any other suitable combination.

Camera 22 is configured to electronically share information with control system 16. Camera 22 is a low resolution digital camera, such as those manufactured by Micron. Those of skill in the art will recognize that it is possible to replace camera 22 with an image sensor or any other suitable device without departing from the spirit of the invention. Camera 22 is located inside cabinet 20 and is oriented to view surface 19 of screen 18. Although camera 22 is located directly behind the center of screen 18 as illustrated in FIG. 1 and is oriented substantially perpendicular to the screen, any other suitable positions and angles of camera 22 may be used. Camera 22 includes lens 23. Lens 23 may be a fisheye lens, a wide angle lens, or the like, that enables camera 22 to see the entirety of viewing area 37 of screen 18 as well as calibration bezel 31. Camera 22 may be a VGA digital camera and lens 23 may be a fish-eye lens.

For example, if screen 18 is a fifty inch display screen (measured along the diagonal) that measures 43.8 inches along the screen's horizontal and 24.7 inches along the screen's vertical, camera 22 may be located a distance (distance 13) from the screen; this distance may be, for example, 6.4 inches in a cabinet of 14 inches total depth. These measurements are provided merely for illustrative purposes.

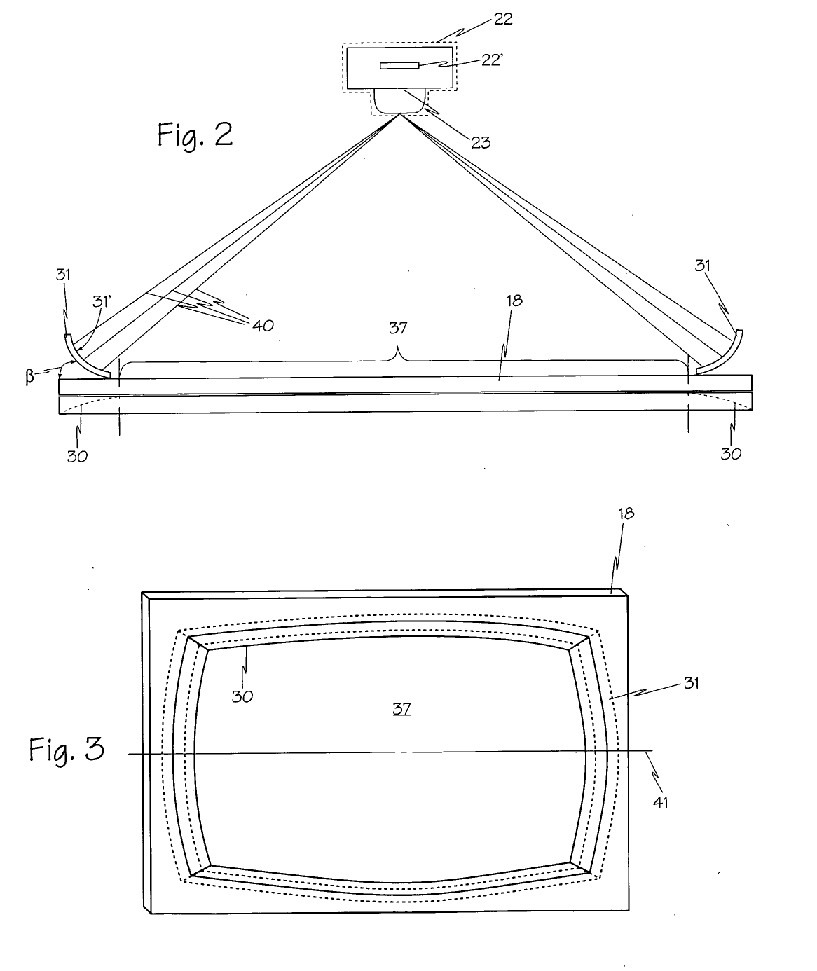

Referring now to FIG. 2, calibration bezel 31 is attached or otherwise secured to screen 18 for the purpose of aiding camera calibration and picture alignment with respect to screen 18. Calibration bezel 31 is located inside cabinet 20, on the same side of screen 18 as surface 19 and may be secured on the inside of screen 18 outside of viewing area 37 and is positioned at an angle β to screen 18. Angle β may be any suitable angle. In a currently preferred configuration, angle β is between 30 and 90 degrees from surface 19 of screen 18. Surface 31′ of calibration bezel 31 is viewable by camera 22. The vertical and horizontal members of the calibration bezel 31 may be disposed at a substantial angle from the plane of the screen 18, and may be substantially perpendicular to screen 18. The bezel may be constructed from thin rectangular strips of material, such as aluminum plate, and may protrude from screen 18 by approximately an inch. Surface 31′ is preferably non-reflective light gray or dark in color. Calibration bezel 31 may form a continuous perimeter around viewing area 37 as illustrated or it may form a discontinuous border around the viewing area. A calibration bezel also need not occupy each edge of viewing screen 37.

The calibration bezel 31 need not be rigidly attached to screen 18 but may instead be attached to a frame securing screen 18 in cabinet 20. In this particular configuration, calibration bezel 31 need not physically touch screen 18.

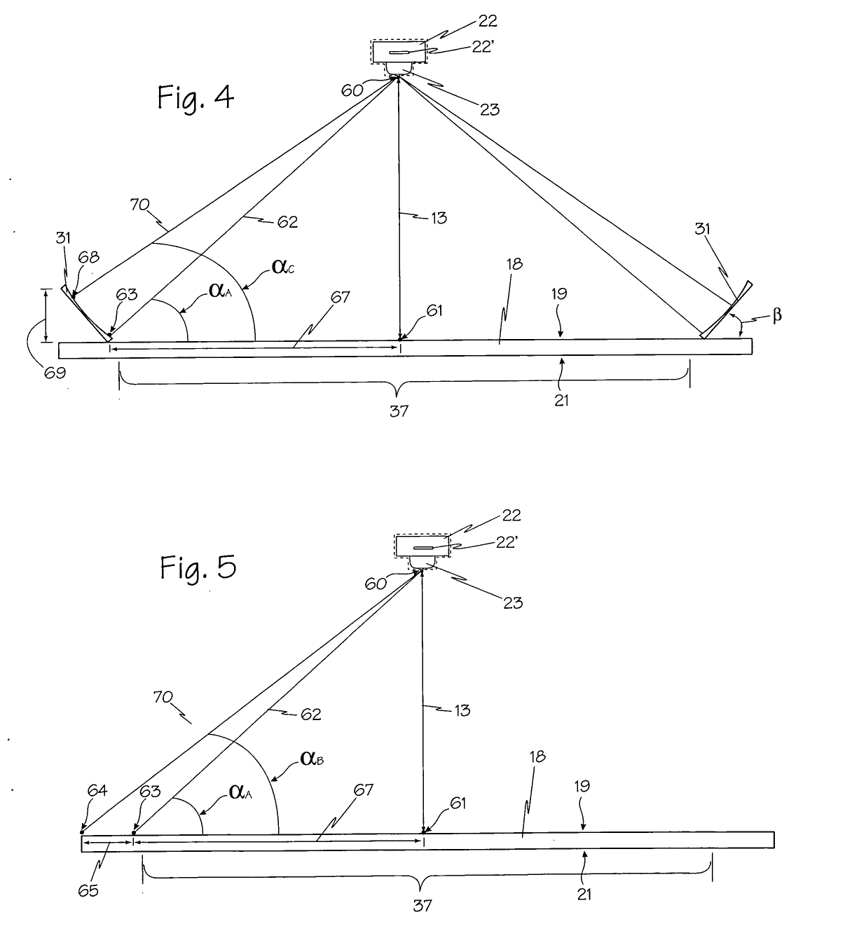

As illustrated schematically in FIGS. 2 and 4, surface 31′ is not flat, but rather is curved. Surface 31′ may be generally concave and is designed to diffusively reflect each light ray 40 to lens 23 at the point where the light ray contacts surface 31. This improves the reflectivity of surface 31′, making it more noticeable in images captured by camera 22. Surface 31′ on each element of a calibration bezel may therefore occupy a portion of a spheroid, and the resulting calibration bezel may form a distorted barrel shape.

Referring now to FIG. 6, surface 31′ may contain fiducials 39 or any other suitable reference marks. The reference marks serve to provide identifiable, known positions that can be easily located within an image captured by camera 22. Video calibration references such as fiducials 39 may be located in predetermined locations; for example, the fiducials may be one inch from corner 35 and one half inch from surface 19 of screen 18. Fiducials 39 may be painted on surface 31′ or, more preferably, molded into the surface of calibration bezel 31. When molded in to surface 31′, a dark spot may be created by making a shadow with the three-dimensionally profiled fiducial. Although two fiducials are shown in FIG. 6 at corner 35, more or fewer fiducials may be used and need not be located at the corners of a calibration bezel such as calibration bezel 31. They may be located at any designated location on surface 31′. Any suitable shape or configuration of calibration references such as fiducial 39 may be used.

A calibration bezel such as bezel 31 may operate as a visual fiducial in images captured by camera 22. This aids the control system, whether it is system 16 or other suitable outside electronics connected to the camera, in locating viewing area 37. Calibration bezel 31 essentially “frames” viewing area 37 in images captured by camera 22 without being visible from front 21. Knowing the location of viewing area 37 within an image captured by camera 22 allows many tasks to be performed, including but not limited to (1) locating where a projected image falls on screen 18, and thereby determining if a projected image is centered on screen 18; (2) calibrating camera 22 by mapping captured image pixels to specific locations on screen 18 or calibration bezel 31, and (3) establishing if a portion of an image projected on screen 18 is distorted, discolored or otherwise in need of correction.

For a feature in an image captured by camera 22 to be identifiable, there must be a substantial difference in the angles subtended by the light rays extending from the feature's borders to lens 23. This large angle corresponds to the feature taking up more pixels on image sensor 22′ in camera 22. The light rays emanating from calibration bezel 31 have a large angle between them, and thus the calibration bezel 31 provides a noticeable boundary around viewing area 37 in images captured by camera 22. This contrasts with a barely visible boundary around the viewing area in the case where only a planar surface extends beyond the screen.

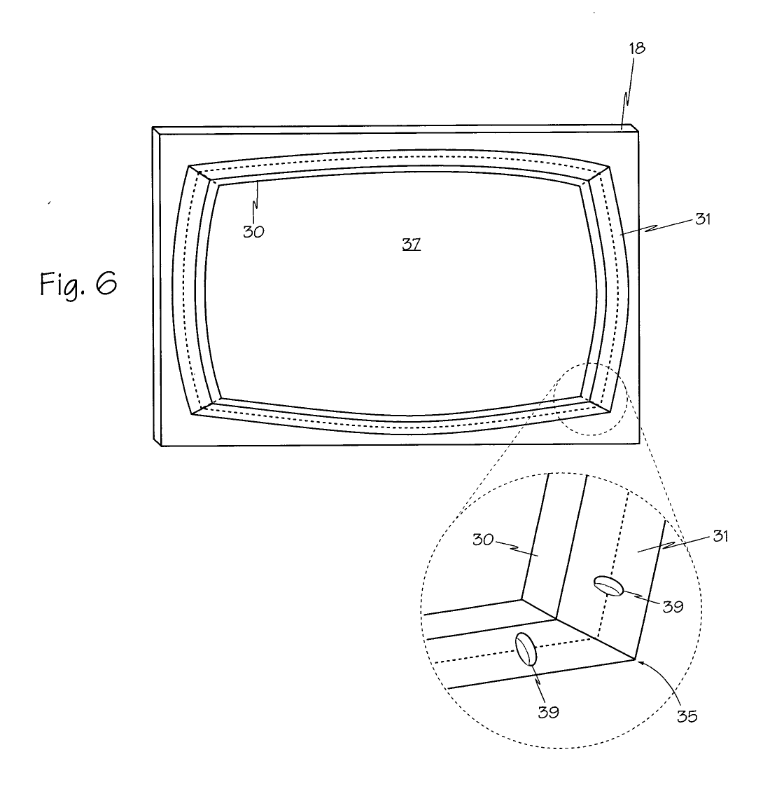

Referring now to FIG. 4, in a detailed view of the geometry of FIG. 2, a reference surface of calibration bezel 31 may be oriented at an angle β relative to screen 18. FIG. 5 is a detailed view of the geometry of FIG. 2 but with calibration bezel 31 removed. Point 63 is located on the vertical edge of viewing area 37, and point 64 is located a distance (distance 65) along horizontal centerline 41 from point 63 on surface 19. Point 60 is located in the center of lens 23. Distance 67 represents half the horizontal length of viewing area 37. Light ray 62 extends from point 63 to point 60, and light ray 66 extends from point 64 to point 60. Angle αa is the angle between light ray 62 and screen 18, and angle αb is the angle between light ray 66 and screen 18. The difference between angle αa and angle αb can be found from the following formula:
αa−αb=tan−1(distance 13/distance 67)−tan−1(distance 13/(distance 67+distance 65))

If, for example, in FIG. 5 distance 13 equals 6.4 inches, distance 67 equals 21.9 inches, and distance 65 equals 1 inch, then αa and angle αb equal 16.3° and 15.6°, respectively, and the difference between the two angles is only 0.7°.

Referring now to FIG. 5, the relative positions of points 60, 61, and 63, as well as distances 13 and 67 are illustrated with reference to display screen 18. Point 68 is located on the end of calibration bezel 31. Calibration bezel 31 extends a distance (distance 69) out from screen 18. Light ray 70 originates at point 68 and ends at point 60, and light ray 62, as before, extends from point 63 to point 60. Angle αa is the angle between light ray 62 and screen 18, and angle αc is the angle between light ray 70 and screen 18. The difference between angle αa and angle αc can be found from the following formula:
αa−αc=tan−1(distance 13/distance 67)−tan−1(distance 13−distance 69)/(distance 67)

If, for example, in FIG. 4 distance 69 equals one inch and all the other distances are the same as before, then αa and angle αc equal 16.3° and 13.9°, respectively, and the difference between the two angles is 2.4°. The angular difference between light rays 62 and 70 versus light rays 62 and 66 is over three times bigger; thus, a one inch wide calibration bezel such as bezel 31 will be much more visible in an image captured by camera 22 if it is oriented at some angle such as perpendicular to screen 18 versus parallel to screen 18.

The geometry of the calibration bezel also reflects light rays towards camera 22, greatly increasing how noticeable the calibration bezel is in images. With reference to FIGS. 1, 4, and 5, it is easy to appreciate how a light ray from projector 12 that reflects off point 63 is more likely to reflect to lens 23 if calibration bezel 31 is in place. Otherwise, the light ray will reflect off the point, away from lens 23.

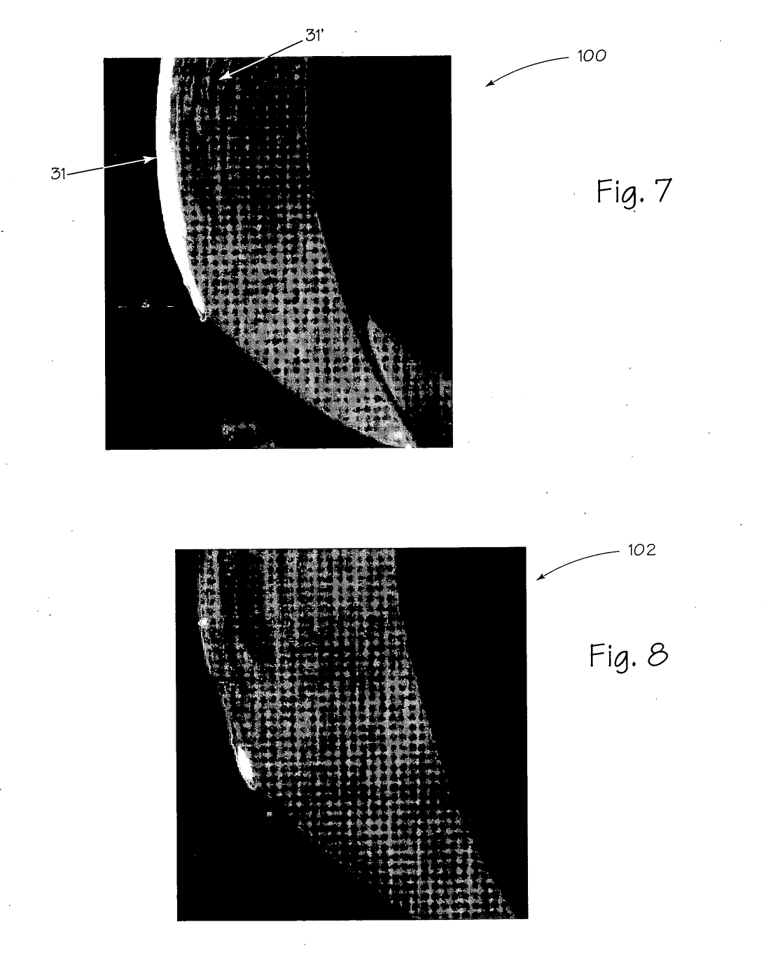

Referring now to FIGS. 7 and 8, the effects a calibration bezel has on captured image quality are illustrated. Both image 100 in FIG. 7 and image 102 in FIG. 8 are portions of images captured by camera 22. The upper left hand corner of screen 18, with respect to the camera's viewpoint, is visible in each figure. Calibration bezel 31 was present on screen 18 when image 100 was captured and was not present on screen 18 when image 102 was captured. The calibration bezel in image 100 is painted a flat or non-reflective gray color and is perpendicular to screen 18. For the portion of the picture visible in FIG. 8 the calibration bezel forms a continuous boundary around screen 18. FIGS. 7 and 8 demonstrate the utility of providing a camera calibration bezel in a rear projection monitor equipped with an alignment camera. The edge of screen 18 is clearly visible in image 100; there is a distinct border in image 100 where the screen visibly ends. This is not the case in image 102 where it is difficult to tell where the border of screen 18 is. The fuzzy, indistinct border in image 102 would make it difficult for electronics to find the defining edges of screen 18.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A video projection system comprising:
a transmissive display screen having a front side and a rear side;
a projector having one or more optical elements forming an image path to the rear side of the display screen;
a calibration bezel in the image path;
means for collecting calibration data having a view of at least a portion of the display screen and at least a portion of the calibration bezel; and
image processing means using collected calibration data to adjust image data for projection by the projector.

2. The video projection system of claim 1 wherein the means for collecting calibration data further comprises:
a digital camera.

3. The video projection system of claim 1 wherein the calibration bezel further comprises:
an aluminum bezel perpendicular to the display screen.

4. The video projection system of claim 1 wherein the calibration bezel further comprises:
an aluminum bezel portion secured at an angle between 30 and 90 degrees to the display screen.

5. The video projection system of claim 1 wherein the calibration bezel further comprises:
an aluminum bezel portion secured at an angle between 30 and 90 degrees to the display screen.

6. The video projection system of claim 1 wherein the calibration bezel further comprises:
an aluminum strip having a securing side and a calibration side, the calibration side forming a concave surface for reflecting image information to the means for collecting calibration data.
